(19) United States
(12) Patent Application Publication
(10) Pub. No.: US 2016/0193799 A1
(43) Pub. Date: Jul. 7, 2016

(54) DEVICE FOR PROCESSING CARDBOARD BLANKS

(71) Applicant: FORTUNA SPEZIALMASCHINEN GMBH, Weil der Stadt (DE)

(72) Inventor: Peter SIGEL, Weil der Stadt (DE)

(73) Assignee: FORTUNA SPEZIALMASCHINEN GMBH, Weil der Stadt (DE)

(21) Appl. No.: 15/068,817

(22) Filed: Mar. 14, 2016

Related U.S. Application Data
(63) Continuation of application No. PCT/EP2014/057106, filed on Apr. 9, 2014.

(30) Foreign Application Priority Data
Sep. 12, 2013 (DE) 102013110065.1

(51) Int. Cl. B31B 1/25

(52) U.S. Cl. CPC B31B 1/25; B31B 2201/25

(57) ABSTRACT

A device for processing cardboard blanks, in particular of plastic laminated beverage cardboards, comprises a scarfing station including a scarfing device for scarfing blanks by means of a bell knife, wherein the scarfing device comprises a housing, whereon a knife shaft is received rotatably, at which a bell knife is received exchangeably, and further comprising a drive motor for the knife shaft, wherein the housing at one side is held by means of a hinge in a preadjusted working position within which the bell knife allows the scarfing of blanks, and wherein a locking device is coupled with the at least one hinge to allow either a locking of the scarfing device in the working position, or a pivoting into a maintenance position or a lifting of the scarfing device upwardly for exchanging the bell knife.

### CROSS REFERENCES TO RELATED APPLICATIONS

This application is a continuation of international patent application PCT/EP2014/057106, filed on Apr. 9, 2014 designating the U.S., which international patent application has been published in German language and claims priority from German patent application 10 2013 110 065.1, filed on Sep. 12, 2013. The entire contents of these priority applications are incorporated herein by reference.

### BACKGROUND OF THE INVENTION

The invention relates to a device for the processing of cardboard blanks, in particular of plastic laminated beverage cardboards, comprising a scarfing station including a scarfing device for scarfing cardboard blanks by means of a bell knife, wherein the scarfing device comprises a housing at which a knife shaft is received rotatably, whereon a belt knife is received exchangeably, and further comprising a drive motor for the knife shaft.

Such a device is known from EP 1 908 578 A1. The known device is suitable for folding and gluing together plastic laminated blanks, in particular of PE-laminated beverage cardboards.

Beverage packagings which are used for milk beverages and fruit beverages are made of plastic laminated blanks, in particular of blanks which are laminated with polyethylene (PE). To generate a close packaging from a flat blank, in the beginning the blank must be scarfed at a scarfing station in the range of the scarfing station, i.e. ist must be cut parallel at the plastic layer lamination. Thereafter the blank in subsequent stations is grooved, folded several times and glued together. In addition on the opposite face of the side face to be glued together a so-called pre-folding must be generated to ensure food compatibility. For pre-folding the plastic layer lamination is in the beginning scarfed selectively at the rim side and thereafter after folding about a previously generated folding line is glued together under pressure with the adjacent section of the blank. Herein the gluing together is performed by a previously locally sufficiently heated plastic layer lamination.

According to the previous mentioned EP 1 908 578 A1 the cardboard blanks are firstly scarfed at the region of a side edge, to selectively peel off the plastic layer lamination, to which end a scarfing device comprising a bell knife is used.

In this document it is not disclosed how the scarfing device including the bell knife is located at the whole device for folding and gluing together cardboard blanks.

However, in devices which have become known in the prior art by public use, the scarfing device is integrated in the whole device as a fixed station, and it is difficult to exchange a worn bell knife. It must be taken into account that such devices for the processing of beverage cardboards work at very high processing speeds in the range of about 1000 m/min.

For exchanging the bell knife, which is due after about 800 to 1000 operating hours, the complete device must be shut down, the scarfing device must be disassembled, the bell knife must be exchanged, and thereafter the scarfing device must be assembled and adjusted again.

This leads to large down times in the range of 30 to 60 min, this leading to respective losses of production.

### SUMMARY OF THE INVENTION

In view of this it is a first object of the invention disclose scarfing device for scarfing blanks by means of a bell knife being configured for a fast exchange of said bell knife in case the bell knife becomes blunt.

It is a second object of the invention to disclose a scarfing device allowing for an automatic or semi-automatic exchange of the bell knife.

It is a third object of the invention to disclose a scarfing device comprising a bell knife that is easily exchangeable.

According to a first aspect of the invention these and other objects are solved by a device for processing cardboard blanks, comprising a scarfing station, said scarfing station comprising a scarfing device for scarfing blanks by means of a bell knife, said scarfing device comprising:
a housing;
a knife shaft being received rotatably within said housing;
a bell knife being received exchangeably on said knife shaft;
a drive motor for driving said knife shaft;
   wherein said scarfing station comprises at least one hinge engaging said housing for holding said housing in a preadjusted working position, wherein said bell knife is configured for scarfing said cardboard blanks;
   a locking device engaging said at least one hinge being movable between a locked mode and an unlocked mode, so as to hold said scarfing device in said working position when being in said locked mode, or to allow a moving of said housing into a maintenance position for exchanging the bell knife when being in said unlocked mode, either by pivoting said housing about said at least one hinge or by lifting said housing with said scarfing device upwardly.

Since according to the invention the housing of the scarfing device is held at one side by means of at least one hinge in a pre-adjusted working position, the scarfing device can either be locked by means of the locking device in the working position, or after unlocking of the locking device the scarfing device can be pivoted into a maintenance position so that the bell knife is directly accessible for exchange, or alternatively the complete scarfing device after unlocking of the locking device can be lifted upwardly from the device, to which end preferably a stationary lifting tool can be utilized, so that the scarfing device can be directly exchanged for a different scarfing device.

If the scarfing device is pivoted into the maintenance position, that means a pivoting about roughly 90° outwardly, whereby the bell knife is directly accessible and can easily be exchanged. However, if the complete scarfing device after unlocking the locking device is lifted upwardly, e.g. by means of a travel slider of a crane extending along the ceiling, than the scarfing device can be exchanged for a different scarfing device.

If after exchanging the bell knife the scarfing device shall be again brought into the working position, then, due to the fact that the hinge is held in the pre-adjusted working position, it is ensured that the original adjusting of the scarfing device is maintained so that after exchanging the bell knife or after exchanging the scarfing device, respectively, the production process may be directly resumed without tedious efforts of adjusting works.

According another aspect of the invention in the longitudinal direction an adjustable adjusting slider is provided, whereon at least one hinge is received.

In this way a simple and fast adjusting possibility is ensured for the scarfing device with respect to the blanks, wherein the pre-adjusted working position also after unlocking the locking device is kept.

According to a further aspect of the invention the at least one hinge is configured as a detachable hinge which is coupled to the locking device.

In this way the hinge can easily be locked in the working position and can easily be transferred into a position for exchanging the bell knife after unlocking the locking device.

Due to the detachable hinge the complete scarfing device can easily be assembled or disassembled, or alternatively, can be pivoted from the working position into the maintenance position.

According another aspect of the invention the detachable hinge comprises a first hinge element which is connected with the housing of the scarfing device, and further a second hinge element which is connected with the adjusting slider, and whereon the second hinge element can be fixed in a predefined location.

Herein preferably the second hinge element comprises a centering within which the first hinge element can be fixed by means of a stud.

By means of these measures a simple design of the detachable hinge is made possible, while at the same time an assembly of the hinge serves for centering the second hinge element to the first hinge element so that a predefined location results.

Herein preferably the recess is configured as a substantially U-shaped recess.

Thereby a simple centering is ensured.

According to another aspect of the invention the locking device comprises a locking element biased into the working position for locking the second hinge element to the first hinge element in the working position.

In this way an easy and failure-tolerant locking possibility for the detachable hinge is ensured. If the locking device itself should fail, then by means of the biasing of the locking element it is always ensured that the hinge is locked in its working position.

According to another aspect of the invention the locking device can be activated pneumatically, preferably by means of a pneumatic cylinder.

In this way an easy and fast activation is made possible.

According to another aspect of the invention the drive motor is coupled to the knife shaft by means of a coupling element, wherein the coupling element cooperates with a clamping device by means of which the coupling element is movable between an entrainment position within which the knife shaft is driven by the drive motor, and a release position within which the coupling element is released from the knife shaft.

In this way for a fast exchange of the bell knife also a fast release of the coupling element is made possible for bringing the scarfing device into a position suitable for exchanging the bell knife or exchanging the scarfing device.

Preferably, herein the drive motor is coupled to the knife shaft by means of a belt drive, wherein the belt is guided over a pulley which can be moved between the entrainment position and the released position by means of an actuator.

Herein the actuator may comprise a pneumatic cylinder.

By these features a simple and fast transition of the drive motor between the entrainment position and the released position is made possible.

According to another aspect of the invention the device further includes at least one further station which is configured as a grooving station for generating at least one folding line at a blank, as a heating station for selectively heating a plastic layer lamination of a blank to be glued, as a folding station for folding a blank, or as a pressing station for pressing and gluing together of a folded blank.

In this way the device is suitable for a complete processing of blanks for producing food-compatible closed packagings from the blanks.

Is should be understood that the afore-mentioned features and to be explained hereinafter cannot only be utilized in the given combination but also in different combinations or independently, without departing from the scope of the invention.

### BRIEF DESCRIPTION OF THE DRAWINGS

Further features and advantages of the invention can be taken from the subsequent description of a preferred embodiment with reference to the drawings. In the drawings show:

FIG. 1 a schematic representation of a device according to the invention for the processing of cardboard blanks, including different processing stations for the processing of plastic laminated beverage cardboards;

FIG. 2 a view of the scarfing station including the scarfing device, seen from the engaging side of the bell knife;

FIG. 3 a perspective view of the scarfing station seen from the side, however after removal of the scarfing device;

FIG. 4 a perspective view of the table including the adjusting slider, whereon the hinges for receiving the scarfing device are received;

FIG. 5 an enlarged view of a hinge, partially sectioned, including an assigned locking device;

FIG. 6 a perspective view of the hinge including the locking device according to FIG. 5; and

FIG. 7 a simplified, schematic representation of the drive motor including the belt drive for driving the knife shaft according to FIG. 2.

### DESCRIPTION OF PREFERRED EMBODIMENTS

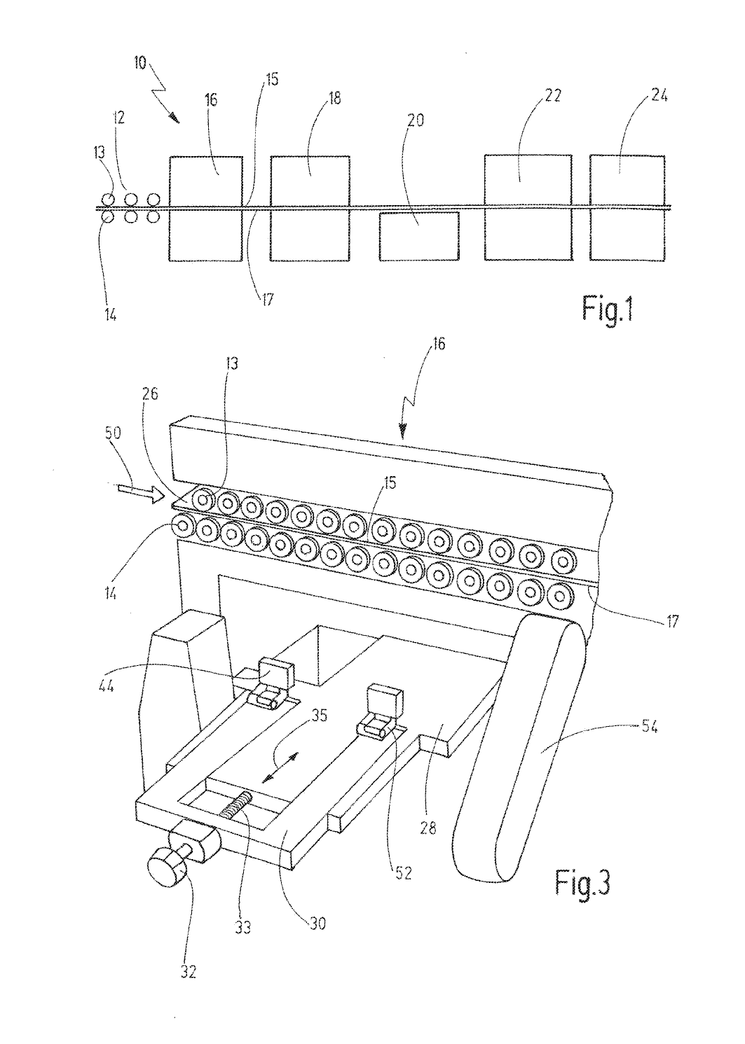

In FIG. 1 a device according to the invention for the processing of cardboard blanks is shown schematically and depicted in total with numeral 10. It is configured as a device for the folding and gluing together of plastic laminated cardboard blanks, in particular of PE-laminated beverage cardboards, for which beverage packages are folded and glued together. These blanks on the lateral inner side of the package to be made are fully laminated with a thin polyethylene layer. These blanks are moved by means of a transport device 12 through the individual stations 16, 18, 20, 22, 24 at a high processing speed of several hundred m/min up to about 1000 m/min. The transport device 12 comprises belts 15, 17 driven by means of rollers 13, 14, wherein the blanks can be moved between the belts. In FIG. 1 only in the beginning region of the device 10 some rollers 13 are depicted above the upper transport belt 15 and some rollers 14 below the lower transport belt 17. It is understood however, that the two transport belts 15, 17 extend at a suitable distance parallel to each other through the complete device and are each guided by means of respective rollers from above and from below.

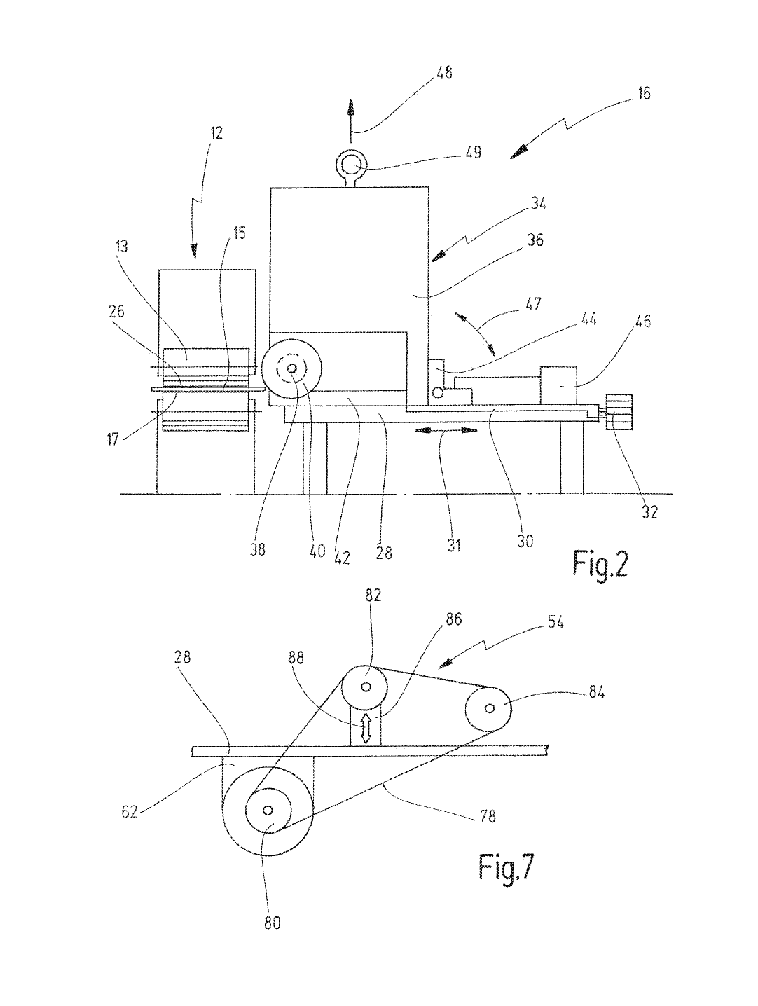

In a first station 16 being configured as a scarfing station, the blanks in the beginning are scarfed at the region of a side edge to selectively remove the plastic layer lamination. To this end a scarfing device 34 including a bell knife 40 is provided (see FIG. 2), the design of which is explained hereinafter.

The blanks from the scarfing station 16 move to a grooving station 18, wherein one or more grooves are generated, which serve as later folding lines. This may e.g. be generated by means of suitable rollers having a respective protrusion at its outer periphery on the one hand, and by an assigned counter roller with a respective recess on the other hand.

From the grooving station 18 the blanks arrive at a heating station 20 within which the blanks in the region of a gluing to be generated later are selectively heated at an outer edge so far that the plastic layer lamination is sufficiently heated to ensure a later gluing together under pressure effect.

From the heating station 20 the blanks proceed to a folding station 22, wherein a simple or multiple folding of the blanks about the respective folding lines is generated.

A folding can for instance be generated by guiding the blanks in the region of the folding line between opposite rollers which along the extension of the folding station are offset to each other gradually by small angles so that finally the roller pair at the end of the folding station is offset to the roller pair at the beginning of the folding station by about 90° which leads to a folding by 90°.

From the folding station 22 the blanks finally advance to the pressing station 24, within which a plastic layer lamination that before has been sufficiently heated within the heating station 20 at its edge side is glued and pressed together with the opposite edge of the folded blank. This again can be done by means of suitable roller pairs through which the blanks are guided.

Now in the following the configuration of the scarfing station 16 is explained in more detail with reference to FIGS. 2 to 7.

FIG. 2 shows the design of a scarfing station 16 in simplified representation. Between the upper rollers 13 and the lower rollers 14 of the transport device 12 extend the upper belt 15 and the lower belt 17. Therebetween the blanks 26 are transported. For processing a blank 26 at the scarfing station 16 there is provided a scarfing device depicted in total with 34 and including a bell knife 40. The scarfing device 34 comprises a housing 36 including a frame 42 at its lower end. In the lower region of the housing 36 a knife shaft 38 is supported on a side facing the transport device 12, a bell knife 40 being received at the front end of the knife shaft. The bell knife is driven by means of the knife shaft 38 at high rotational speed so that blanks 26 which are moved through the device by means of the transport device 12 at high speed using the transport belts 15, 17 are scarfed by means of the bell knife 40, i.e. in this case the plastic layer lamination is selectively peeled off.

The scarfing device 34 is held upon a table 28. At the table 28 an adjusting slider 30 can be adjusted in longitudinal direction, i.e. in the direction of the transport device 12 by means of an adjusting wheel 32, as indicated by arrow 31. The scarfing device 34 is fixed at the lower end of its housing 34 on a side facing away from the transport device 12 to a frame 42 at two hinges (only one hinge 44 can be seen in FIG. 2) to the adjusting slider 30, both hinges acting together with a locking device 46. Thus the hinges are located at a side remote from the bell knife 40 so that basically a pivoting of the scarfing device 34 about the hinges 44 by 90° to the outside is possible, as indicated by arrow 47.

In the position pivoted to the outside the bell knife 40 can be easily accessed and can be exchanged.

Alternatively, the complete scarfing device 34, after releasing the hinges 44 can be lifted upwardly by means of a lifting device, such as a travel slider of crane, to which end for instance on the top side a lug 49 may be provided. The lifting of the scarfing device 34 and the exchange for a different scarfing device including a fresh, sharpened bell knife 40 allows for an even faster powering up than an exchange of the bell knife 40, since in this case the sharpening of bell knife 40 can be dispensed with.

FIG. 3 shows the design of the table 28 and of the adjusting slider 30 arranged thereon in more detail, with the two hinges 44 and 52 being supported on the adjusting slider (in FIG. 2 only the first one 44 of the two hinges 44, 52 can be seen). The adjusting slider 30 can be adjusted by means of a threaded rod using the adjusting wheel 32, as indicated by arrow 31. It will be understood that instead of a manual adjusting also an electrically controlled adjusting can be provided.

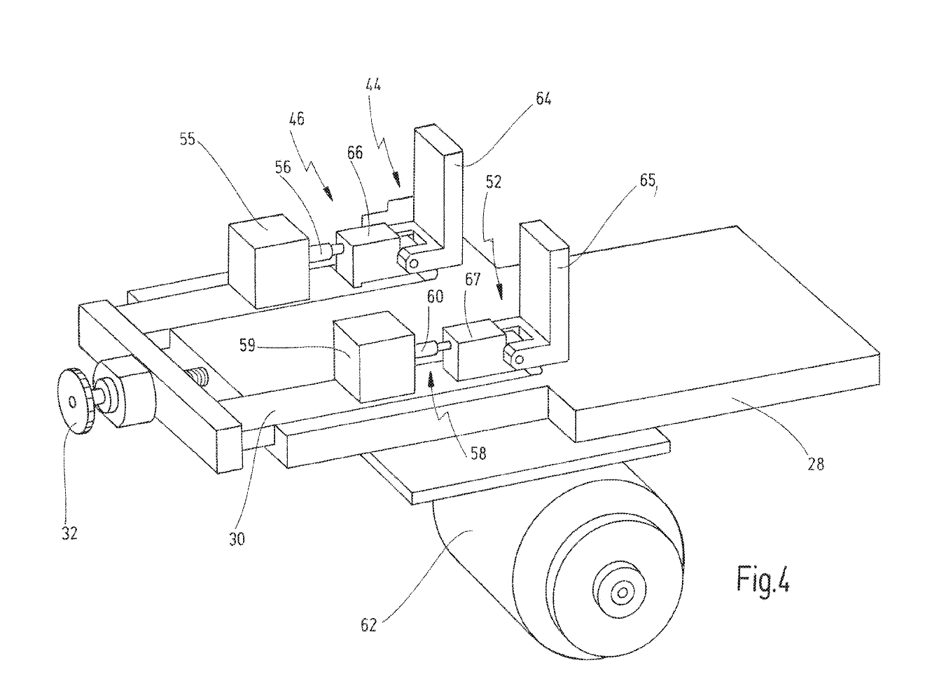

The hinges 44, 52 are fixed to the ends of the adjusting slider 30 facing the rollers 13, 14 and the transport belts 15, 17, respectively. The hinges 44, 52 work together with locking devices which, however are not shown in FIG. 3. The housing 36 of the scarfing device 34 with its frame 42 is screwed together at the lower end with two hinges 44, 52. While the frame 42 with its outer rim is held at the hinges 44, 52, the frame 42 apart from that rests on the flat surface of the table 28 and is pressed onto the surface of the table 28 by means of the considerable dead weight of the scarfing device 34. On the right side of FIG. 3 in addition schematically a belt drive 54 is shown with its protecting housing which serves for driving the knife shaft 38 by means of a motor received below the table 28 (see FIG. 4).

From FIG. 4 the construction of the two hinges 44, 52 can be seen in more detail. The hinges 44, 52 are configured as detachable hinges, each having a first hinge element 64, 65 which, respectively, can be connected with a second hinge element 66, 67.

In the engaged position of the hinge element 64 and the second hinge element 66, or 65 and 67, respectively, shown in FIG. 4, the hinge elements can be locked together by means of the assigned locking devices 46, 58. To this end the die locking devices 46, 58 each comprise a pneumatic actuator 55, 59 by means of which a piston 56 or 60, respectively, can be activated to effect a locking of the hinge elements 64, 66 or 65, 67, respectively.

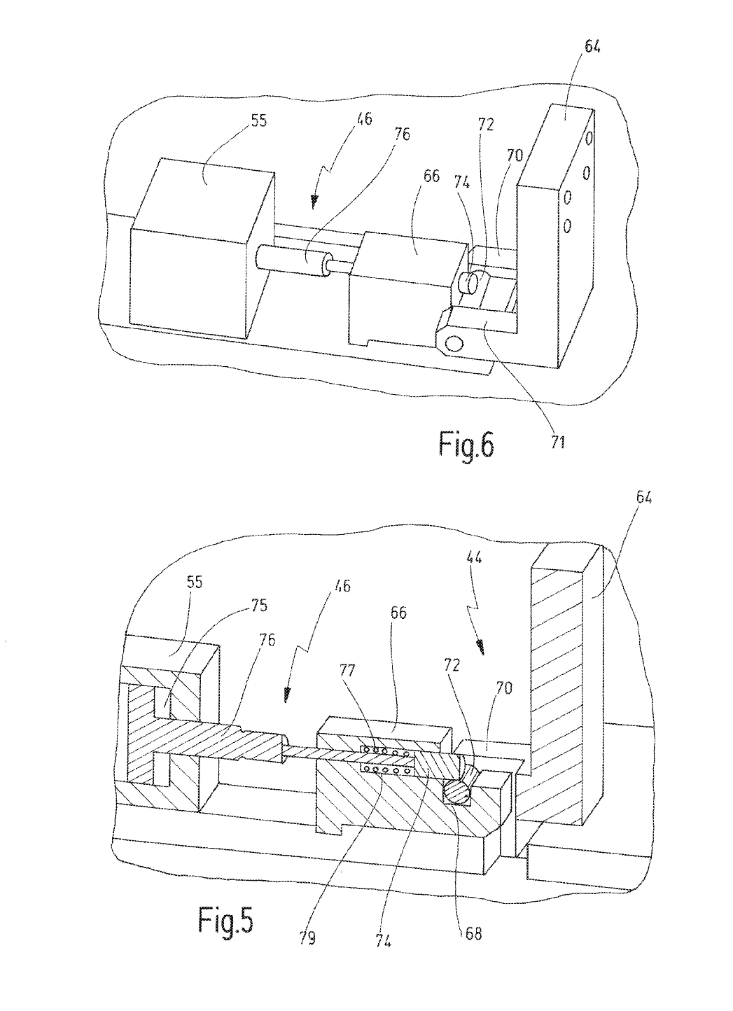

The cooperation of the respective hinge elements with the locking device in the following is described in more detail with reference to FIGS. 5 and 6.

The first hinge element 64 is designed as an angled piece and at its lower end comprises two legs 70, 71 (FIG. 6) between which a cylindrical stud 72 is held. This stud 72 according to FIG. 5 cooperates with an assigned U-shaped recess 68 of the second hinge element 66. The U-shaped recess 68 herein is configured such that after inserting the stud 72 from above simultaneously a centering is ensured which for instance can be effected by side faces tapering slightly conically. In addition in this position a locking to the locking device 46 by means of a locking element 74 is effected. The locking element 74 is configured as a cylindrical stud blocking the stud 72 of the first hinge element 64 from above by protruding laterally beyond it, as can be seen from FIG. 5. The locking element 74 can be slided within an assigned cylindrical recess 79 of the second hinge element 66 at a piston 76 against the force of a helical spring 77. The piston 76 is part of an assigned actuator 55 and acts together with a pneumatically activated cylinder 75 of the actuator 55. Thus the locking element 74 can be moved from the locking position shown in FIG. 5 to the left by means of the piston 76 pneumatically controlled against the action of the helical spring for releasing the stud 72. If the actuator 55 does not act, then the locking element 74 is held in the locking position shown in FIG. 5 by means of the spring force.

The knife shaft 38 is driven by the drive motor 72 by means of a belt drive 54 as mentioned above.

From FIG. 7 it can be seen that the belt drive 54 is guided by a pulley 80 of the drive motor 62 below the table 28, by a belt wheel 84 at the knife shaft 38, and by a further pulley 82. The further pulley 82 can be adjusted by means of an actuator 86, as depicted by the double arrow 88. Herein the actuator preferably also is configured as a pneumatic actuator by means of which a fast shifting of the pulley 82 can be effected for either fully tensioning the belt drive 78 so that the knife shaft 38 can be driven by means of the drive motor 62, or for releasing the belt 78 so that the scarfing device 34 can be either pivoted to the outside, to allow an exchange of the bell knife 40 or to allow a lifting of the scarfing device 34 upwardly.

Of course, it is also conceivable that the knife shaft 38 itself can be designed with a drive directly on the knife shaft so that in this case the belt drive 54 including the actuator 86 can be fully deleted.

If the bell knife 40 is worn out and an exchange of the bell knife is necessary, this preferably is indicated at an assigned controlling device so that the user thereafter can perform the necessary steps for exchanging the bell knife or for completely exchanging the scarfing device 34, preferably guided by a menu. Herein a release of the locking devices 46 and 58 preferably is performed automatically by means of the assigned actuators 55, 59, and simultaneously a release of the belt drive 54 by means of the assigned actuator 86.

In this way a fast pivoting of the scarfing device 34 into a maintenance position for exchanging the bell knife 40 or for a lifting of the scarfing device 34 upwardly, respectively is made possible, in case a full exchange of the scarfing device 34 is preferred.

The down-time of the device in this way is reduced from about 30 to 60 min to 10 min or less.

What is claimed is:

1. A device for processing cardboard blanks, comprising a scarfing station, said scarfing station comprising a scarfing device for scarfing blanks by means of a bell knife, said scarfing device comprising:
a housing;
a knife shaft being received rotatably within said housing;
a bell knife being received exchangeably on said knife shaft;
a drive motor for driving said knife shaft;
wherein said scarfing station comprises at least one releasable hinge engaging said housing for holding said housing in a preadjusted working position, wherein said bell knife is configured for scarfing said cardboard blanks;
wherein a locking device engaging said at least one hinge is movable between a locked mode and an unlocked mode, so as to hold said scarfing device in said working position when being in said locked mode, or to allow a moving of said housing into a maintenance position for exchanging the bell knife when being in said unlocked mode, either by pivoting said housing about said at least one hinge or by releasing said hinge and lifting said housing with said scarfing device upwardly;
wherein said releasable hinge comprises a first hinge element being coupled with said housing, and further comprises a second hinge element, being coupled to said adjusting slider and whereon a second hinge element can be fixed in a predefined location;
wherein said locking device comprises a locking element being biased into said working position for locking said second hinge element with said first hinge element in said working position.

2. The device of claim 1, further comprising an adjusting slider being adjustable in longitudinal direction, whereon said at least one hinge is received.

3. A device for processing cardboard blanks, comprising a scarfing station, said scarfing station comprising a scarfing device for scarfing blanks by means of a bell knife, said scarfing device comprising:
a housing;
a knife shaft being received rotatably within said housing;
a bell knife being received exchangeably on said knife shaft;
a drive motor for driving said knife shaft;
wherein said scarfing station comprises at least one releasable hinge engaging said housing for holding said housing in a preadjusted working position, wherein said bell knife is configured for scarfing said cardboard blanks;
wherein a locking device engaging said at least one releasable hinge is movable between a locked mode and an unlocked mode, so as to hold said scarfing device in said working position when being in said locked mode, or to allow a moving of said housing into a maintenance position for exchanging the bell knife when being in said unlocked mode, either by pivoting said housing about said at least one hinge or by releasing said hinge and lifting said housing with said scarfing device upwardly;
wherein said releasable hinge comprises a first hinge element being coupled with said housing, and further comprises a second hinge element, being coupled to said adjusting slider and whereon a second hinge element can be fixed in a predefined location.

4. The device of claim 3, wherein said releasable hinge comprises a first hinge element being coupled with said housing, and further comprises a second hinge element, being coupled to an adjusting slider being adjustable in longitudinal direction.

5. The device of claim 4, wherein said second hinge element comprises a recess including a centering, wherein said first hinge element can be fixed by means of a stud.

6. The device of claim 5, wherein said recess is configured substantially as a U-shaped recess.

7. The device of claim 4, wherein said locking device comprises a locking element being biased into said working position for locking said second hinge element with said first hinge element in said working position.

8. The device of claim 7, wherein said locking element is configured at a piston on said second hinge element biased by a spring, serving for locking said second hinge element with said first hinge element in said working position.

9. The device of claim 1, further comprising a pneumatic cylinder for moving said locking device between said locking and said unlocking modes.

10. The device of claim 1, wherein said drive motor is coupled to said knife shaft by means of a coupling element, wherein said coupling element cooperates with a clamping device being configured for moving said coupling element between an entrainment position, wherein said knife shaft is driven by said drive motor, and a released position wherein said coupling element is released from said knife shaft.

11. The device of claim 10, further comprising a belt drive for coupling said drive motor with said knife shaft, said belt drive comprising a belt being guided above a pulley by means of which an actuator can be moved between said entrainment position and the released position.

12. The device of claim 11, wherein said actuator comprises a pneumatic cylinder.

13. A device for processing cardboard blanks, comprising a scarfing station, said scarfing station comprising a scarfing device for scarfing blanks by means of a bell knife, said scarfing device comprising:
a housing;
a knife shaft being received rotatably within said housing;
a bell knife being received exchangeably on said knife shaft;
a drive motor for driving said knife shaft;
wherein said scarfing station comprises at least one hinge engaging said housing for holding said housing in a preadjusted working position, wherein said bell knife is configured for scarfing said cardboard blanks;
a locking device engaging said at least one hinge being movable between a locked mode and an unlocked mode, so as to hold said scarfing device in said working position when being in said locked mode, or to allow a moving of said housing into a maintenance position for exchanging the bell knife when being in said unlocked mode, either by pivoting said housing about said at least one hinge or by lifting said housing with said scarfing device upwardly.

14. The device of claim 13, further comprising an adjusting slider being adjustable in longitudinal direction, whereon said at least one hinge is received.

15. The device of claim 13, wherein said at least one hinge is configured as a releasable hinge being coupled with said locking device.

16. The device of claim 15, wherein said releasable hinge comprises a first hinge element being coupled with said housing, and further comprises a second hinge element, being coupled to an adjusting slider being adjustable in longitudinal direction.

17. The device of claim 16, wherein said second hinge element comprises a recess including a centering, wherein said first hinge element can be fixed by means of a stud.

18. The device of claim 17, wherein said recess is configured substantially as a U-shaped recess.

19. The device of claim 18, wherein said locking device comprises a locking element being biased into said working position for locking said second hinge element with said first hinge element in said working position.

20. The device of claim 13, further comprising at least one further station being configured as station selected from the group consisting of a grooving station for generating at least one folding line on a blank, a heating station for selectively heating a plastic layer lamination of a blank to be glued, a folding station for folding a blank, and a pressing station for pressing and sealing a folded blank.
